(19) United States
(12) Patent Application Publication
(10) Pub. No.: US 2020/0317266 A1
(43) Pub. Date: Oct. 8, 2020

(54) VEHICLE CONTROLLER

(71) Applicants: Toyota Jidosha Kabushiki Kaisha, Toyota-shi (JP); Denso Corporation, Kariya-city (JP)

(72) Inventors: Yoji Kunihiro, Susono-shi (JP); Hisaya Akatsuka, Kariya-city (JP)

(73) Assignees: Toyota Jidosha Kabushiki Kaisha, Toyota-shi (JP); Denso Corporation, Kariya-city (JP)

(21) Appl. No.: 16/829,691

(22) Filed: Mar. 25, 2020

(30) Foreign Application Priority Data
Apr. 3, 2019 (JP) 2019-071613

(51) Int. Cl. B62D 15/02; G01P 5/02

(52) U.S. Cl. CPC B62D 15/029; B60R 11/04; G01P 5/02

(57) ABSTRACT

The vehicle controller according to the present disclosure estimates disturbance acting on a vehicle, and performs driving assistance responsive to the disturbance. When reliability of the estimated disturbance is low, the vehicle controller lowers an assistance level of the driving assistance as compared with a case where the reliability is high. Thereby, it is possible to restrain the driving assistance responsive to the disturbance from causing a driver to feel uncomfortable.

### CROSS-REFERENCE TO RELATED APPLICATION

The present application claims priority under 35 U.S.C. § 119 to Japanese Patent Application No. 2019-071613, filed Apr. 3, 2019. The contents of this application are incorporated herein by reference in their entirety.

### BACKGROUND

### Field

The present disclosure relates to a controller, and more particularly, to a vehicle controller which performs driving assistance in response to disturbance when the disturbance acts on the vehicle.

### Background Art

JP2017-047798A discloses a technique of detecting unsteadiness of vehicle behavior due to disturbance such as a lateral wind, and correcting the unsteadiness of vehicle behavior by driving assistance corresponding to the cause.

However, in the technique described in JP2017-047798A, since the driving assistance is performed after the disturbance is actually detected, the unsteadiness of the vehicle behavior due to the disturbance continues until the driving assistance functions sufficiently.

### SUMMARY

In view of the above-mentioned problems, in the inventive process of the present disclosure, it has been studied to estimate disturbance acting on a vehicle in advance and start driving assistance before unsteadiness of vehicle behavior occurs. However, when the estimated disturbance deviates from disturbance actually acting on the vehicle, excessive driving assistance may cause a driver to feel uncomfortable.

The present disclosure has been made in view of the above problems, and an object thereof is to provide a vehicle controller capable of restraining driving assistance responsive to disturbance from causing a driver to feel uncomfortable.

In order to achieve the above object, a vehicle controller according to the present disclosure includes a disturbance estimating unit that estimates disturbance acting on a vehicle, and a driving assistance unit that performs driving assistance responsive to the disturbance. The vehicle controller according to the present disclosure physically includes at least one processor and at least one memory including at least one program. The at least one program included in the at least one memory is executed by the at least one processor to cause the at least one processor to function as the disturbance estimating unit and the driving assistance unit. When reliability of the disturbance estimated by the disturbance estimating unit is low, the driving assistance unit lowers an assistance level of the driving assistance as compared with a case where the reliability is high.

According to the vehicle controller of the present disclosure, when the reliability of the estimated disturbance is relatively high, driving assistance with a relatively high assistance level is performed in response to the estimated disturbance, thereby preventing unsteadiness of the vehicle behavior due to the disturbance. On the other hand, in a case where the reliability of the estimated disturbance is relatively low, the assistance level of the driving assistance is lowered, so that even if the driving assistance is performed despite the fact that the disturbance does not actually act, the driving assistance is restrained from causing the driver to feel uncomfortable.

In the vehicle controller according to the present disclosure, the disturbance estimating unit may estimate a lateral wind received by the vehicle, and the driving assistance may include lateral driving assistance acting on lateral motion of the vehicle and longitudinal driving assistance acting on longitudinal motion of the vehicle. In this case, when the reliability of the lateral wind estimated by the disturbance estimating unit is low, the driving assistance unit may lower an assistance level of the longitudinal driving assistance more than an assistance level of the lateral driving assistance compare to a case where the reliability is high. Even if a lateral wind is estimated by the disturbance estimating unit, when the reliability of the lateral wind is low, it is highly likely that the vehicle does not actually receive the lateral wind. In a situation where the vehicle is unlikely to be subjected to a lateral wind, by lowering the assistance level of the longitudinal driving assistance more than the assistance level of the lateral direction driving assistance, the longitudinal driving assistance is restrained from causing the driver to feel uncomfortable. On the other hand, by keeping the assistance level of the lateral driving assistance having a higher contribution to the responsiveness to the lateral wind relatively high, it is possible to suppress unsteadiness of the vehicle behavior when the vehicle is actually subjected to the lateral wind.

In the vehicle controller according to the present disclosure, the disturbance estimating unit may estimate a lateral wind received by the vehicle, and the driving assistance may include longitudinal driving assistance acting at least on longitudinal motion of the vehicle. In this case, when the reliability of the lateral wind estimated by the disturbance estimating unit is low, the driving assistance unit may lower an assistance level of the longitudinal driving assistance as compared with a case where the reliability is high. Even if a lateral wind is estimated by the disturbance estimating unit, when the reliability of the lateral wind is low, it is highly likely that the vehicle does not actually receive the lateral wind. In a situation where the vehicle is unlikely to be subjected to a lateral wind, by lowering the assistance level of the longitudinal driving assistance, the longitudinal driving assistance is restrained from causing the driver to feel uncomfortable.

In the vehicle controller according to the present disclosure, the disturbance estimating unit may estimate a lateral wind received by the vehicle, and the driving assistance may include lateral driving assistance acting at least on lateral motion of the vehicle. In this case, when the reliability of the lateral wind estimated by the disturbance estimating unit is low, the driving assistance unit may lower an assistance level of the lateral driving assistance as compared with a case where the reliability is high. Even if a lateral wind is estimated by the disturbance estimating unit, when the reliability of the lateral wind is low, it is highly likely that the vehicle does not actually receive the lateral wind. In a situation in which the vehicle is unlikely to be subjected to a lateral wind, by lowering the assistance level of the lateral driving assistance, the lateral driving assistance is restrained from causing the driver to feel uncomfortable.

The vehicle controller according to the present disclosure may include a determination unit that determines a responsiveness of a driver to a steering operation. In this case, when the responsiveness of the driver to the steering operation determined by the determination unit is high, the driving assistance unit may lower an assistance level of the driving assistance as compared with a case where the responsiveness is low. In a situation in which the driver can cope with disturbance acting on the vehicle by the steering operation, by lowering the assistance level of the driving assistance responsive to the disturbance, the driving assistance is restrained from causing the driver to feel uncomfortable.

The vehicle controller according to the present disclosure may include a preceding vehicle recognizing unit that recognizes a preceding vehicle traveling ahead of the vehicle. In this case, the disturbance estimating unit may estimate a lateral wind received by the vehicle from the behavior of the preceding vehicle recognized by the preceding vehicle recognizing unit. If the behavior of the preceding vehicle traveling ahead is unsteady in the lateral direction, the lateral wind is likely to be the cause of the unsteadiness, and the behavior of the vehicle is likely to be unsteady. Therefore, by monitoring the behavior of the preceding vehicle, it is possible to estimate in advance the lateral wind to which the vehicle is subjected. As the number of preceding vehicles whose behavior is unsteady increases, the reliability of the estimated lateral wind can be increased.

The vehicle controller according to the present disclosure may include an infrastructure information acquiring unit for acquiring infrastructure information relating to a traveling condition of a road on which the vehicle is traveling. In this case, the disturbance estimating unit may correct the reliability of the lateral wind estimated from the behavior of the preceding vehicle based on the infrastructure information acquired by the infrastructure information acquiring unit. According to the infrastructure information, it is possible to predict in advance that the vehicle is subjected to a lateral wind, and therefore, by adding the infrastructure information to the estimation of a lateral wind based on the behavior of the preceding vehicle, it is possible to estimate a lateral wind more accurately.

The vehicle controller according to the present disclosure may include a location recognizing unit that recognizes a location where the vehicle is traveling. In this case, the disturbance estimating unit may correct the reliability of the lateral wind estimated from the behavior of the preceding vehicle based on the location recognized by the location recognizing unit. The location where the vehicle is traveling may or may not be susceptible to a lateral wind. By adding the location where the vehicle is traveling to the estimation of a lateral wind based on the behavior of the preceding vehicle, a more accurate estimation of a lateral wind becomes possible.

The vehicle controller according to the present disclosure may acquire infrastructure information relating to a traveling condition of a road on which the vehicle is traveling, and estimate the lateral wind received by the vehicle from the infrastructure information, not from the behavior of the preceding vehicle. In this case, the higher the intensity of the lateral wind included in the infrastructure information, the higher the reliability of the estimated lateral wind.

According to the above-described vehicle controller of the present disclosure, when the reliability of the estimated disturbance is low, the assistance level of the driving assistance is lowered as compared with a case where the reliability is high. As a result, even if the driving assistance is performed despite the fact that disturbance does not actually act, the driving assistance is restrained from causing the driver to feel uncomfortable.

### BRIEF DESCRIPTION OF THE DRAWINGS

FIG. 1 is a block diagram showing a configuration of a control system of an autonomous vehicle in which a vehicle controller of an embodiment of the present disclosure is mounted.

FIG. 2 is a diagram for explaining estimation of a lateral wind based on behavior of a preceding vehicle;

FIG. 3 is a diagram for explaining estimation of a lateral wind based on infrastructure information;

FIG. 4 is a diagram for explaining estimation of a lateral wind based on a location where the vehicle is traveling;

FIG. 5 is a table in which contents of driving assistance control responsive to disturbance is described for each level of wandering reliability;

FIG. 6 is a table describing switching of control according to a steering condition of a driver;

FIG. 7 is a diagram for explaining an offset of a target trajectory;

FIG. 8 is a diagram illustrating a feedback control of a steering angle responsive to disturbance;

FIG. 9 is a diagram showing an example of a target lateral acceleration and a target yaw rate;

FIG. 10 is a diagram showing an example of a lateral acceleration difference value and a yaw rate difference value;

FIG. 11 is a flowchart showing a control flow of a first example of the driving assistance control responsive to disturbance;

FIG. 12 is a flowchart showing a control flow of a second example of the driving assistance control responsive to disturbance;

FIG. 13 is a flowchart showing a control flow of a third example of the driving assistance control responsive to disturbance;

FIG. 14 is a flowchart showing a control flow of a fourth example of the driving assistance control responsive to disturbance; and

FIG. 15 is a flowchart showing a control flow of a fifth example of the driving assistance control responsive to disturbance.

### DETAILED DESCRIPTION

Hereunder, an embodiment of the present disclosure will be described with reference to the drawings. Note that when the numerals of numbers, quantities, amounts, ranges and the like of respective elements are mentioned in the embodiment shown as follows, the present disclosure is not limited to the mentioned numerals unless specially explicitly described otherwise, or unless the disclosure is explicitly specified by the numerals theoretically. Furthermore, configurations that are described in the embodiment shown as follows are not always indispensable to the disclosure unless specially explicitly shown otherwise, or unless the disclosure is explicitly specified by the structures or the steps theoretically.

### 1. CONFIGURATION OF CONTROL SYSTEM OF AUTONOMOUS VEHICLE

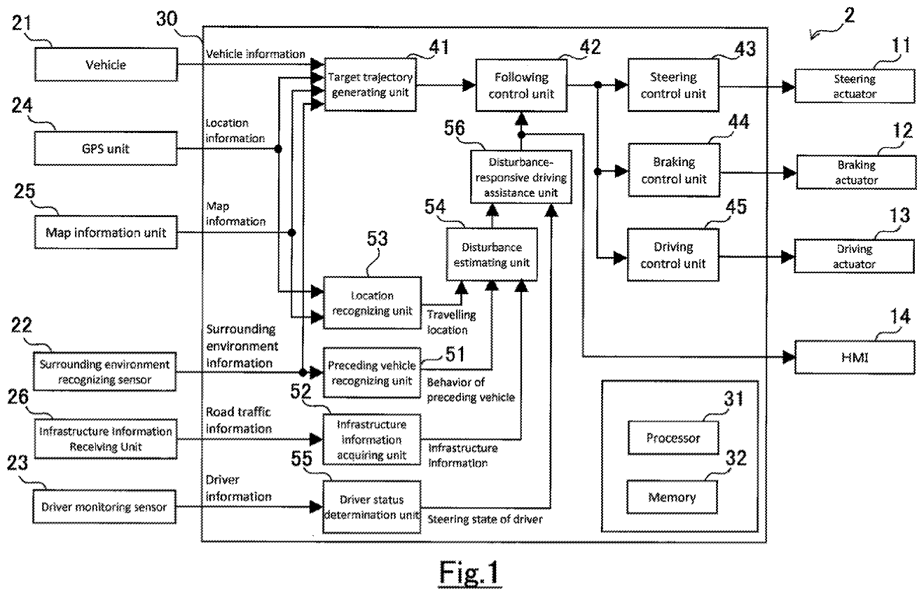

The vehicle controller according to the embodiment of the present disclosure is a vehicle controller for automatic driving mounted on an autonomous vehicle, and is a controller capable of realizing an automatic driving level equal to or higher than level 3 in the level definition of SAE (Society of Automotive Engineers), for example. An autonomous vehicle on which the vehicle controller of the present embodiment is mounted has a control system having a configuration shown in a block diagram in FIG. 1, for example.

The autonomous vehicle (hereafter, simply referred as vehicle) 2 includes a vehicle sensor 21, a surrounding environment recognizing sensor 22, a driver monitoring sensor 23, a GPS unit 24, a map information unit 25, and an infrastructure information receiving unit 26. These are electrically connected to a vehicle controller 30 directly or via an in-vehicle network (a communication network such as CAN (Controller Area Network) built in the vehicle 2).

The vehicle sensor 21 is a sensor that acquires information on the motion state of the vehicle 2. The vehicle sensor 21 includes, for example, a speed sensor for measuring the traveling speed and the longitudinal acceleration of the vehicle 2 from the rotational speed of a wheel, an acceleration sensor for measuring the acceleration acting on the vehicle 2, a yaw rate sensor for measuring the turning angular speed of the vehicle 2, and the like.

The surrounding environment recognizing sensor 22 is an autonomous sensor that acquires information on the surrounding environment of the vehicle 2. The surrounding environment recognizing sensor 22 includes a camera, a millimeter-wave radar, and a LIDAR. From the information obtained by the surrounding environment recognizing sensor 22, the shape of an object existing in the periphery of the vehicle 2, the relative position and the relative speed of the object with respect to the vehicle 2 can be recognized. Further, particularly from camera images, it is possible to recognize a section line of a road such as a roadway outside line, a roadway boundary line, and a roadway center line.

The driver monitoring sensor 23 is a sensor for acquiring information on the state of the driver. In this application, “driver” means the driver of the vehicle 2. The driver monitoring sensor 23 includes a touch sensor for detecting that the driver touches a steering wheel, and a torque sensor for detecting a steering input to the steering wheel of the driver. Also included in the driver monitoring sensor 23 are an in-vehicle camera for monitoring facial expression or posture of the driver, a biological sensor for detecting biological signals such as a heartbeat and a pulse, and the like.

The GPS unit 24 is a device that receives position information provided by GPS satellites. Based on the position information provided from the GPS satellites, the current position of the vehicle 2 can be known. The map information unit 25 is a database storing various map information such as positions of roads, shapes of roads, and lane structures. By comparing the current position of the vehicle 2 with the map information, the position of the vehicle 2 on the map can be specified. When the vehicle controller 30 is connectable to the Internet, the map information unit 25 does not necessarily have to be mounted on the vehicle 2, and may exist on the Internet.

The infrastructure information receiving unit 26 is a device for receiving infrastructure information provided from the outside. The infrastructure information is provided with the form of FM multiplex broadcasting signal transmitted from an FM broadcasting station, or optical beacons or radio beacons transmitted from a road facility. The infrastructure information includes not only traffic congestion information and traffic regulation information but also weather information such as wind, rain and snow.

The vehicle 2 includes a steering actuator 11 for steering the vehicle 2, a braking actuator 12 for decelerating the vehicle 2, and a driving actuator 13 for accelerating the vehicle 2. The steering actuator 11 includes, for example, a power steering system using a motor or a hydraulic pressure, and a steer-by-wire steering system. The braking actuator 12 includes, for example, a hydraulic brake and a power regeneration brake. The driving actuator 13 includes, for example, an engine, an EV system, a hybrid system, a fuel cell system, and the like. The actuators 11, 12, and 13 are electrically connected to the vehicle controller 30 directly or via an in-vehicle network. A HMI14 for exchanging data between the driver and the vehicle controller 30 is provided in the cabin of the vehicle 2.

The vehicle controller 30 is an Electronic Control Unit (ECU) having at least one processor 31 and at least one memory 32. Various programs for automatic driving and various data including a map are stored in the memory 32. The program includes a program for driving assistance control responsive to disturbance described later. The processor 31 executes the program stored in the memory 32, whereby various functions are realized in the vehicle controller 30. The vehicle controller 30 may be a group of a plurality of ECUs.

### 2. FUNCTION OF THE VEHICLE CONTROLLER

In FIG. 1, among the functions of the vehicle controller 30, in particular, functions related to automatic driving are represented by a plurality of blocks. Other functions of the vehicle controller 30 are not shown. The vehicle controller 30 includes a target trajectory generating unit 41, a following control unit 42, a steering control unit 43, a braking control unit 44, and a driving control unit 45 as functions related to automatic driving. However, these units are not present as hardware in the vehicle controller 30, but are realized by software when a program stored in the memory 32 is executed by the processor 31.

The target trajectory generating unit 41 calculates a travel route of the vehicle 2 to a destination. For example, the center line of a traveling lane defined from two section lines recognized from camera images may be calculated as the traveling route of the vehicle 2, or the traveling lane may be recognized using the map information and the position information of the vehicle 2, and the traveling route may be calculated based on the recognized traveling lane. The target trajectory generating unit 41 acquires information on the motion state of the vehicle 2 from the vehicle sensor 21, and generates a target trajectory of the vehicle 2 for causing the vehicle 2 to travel along the travel route based on the current position and the motion state of the vehicle 2.

The target trajectory is a trajectory to be taken by the vehicle 2 a few seconds or tens of seconds from the present, and is set along the travel route. Specifically, the target trajectory is a trajectory drawn by connecting target positions of the vehicle in a predetermined coordinate system, and is represented by, for example, a set of control points represented by X coordinates and Y coordinates. The coordinate system representing the target trajectory may be, for example, an absolute coordinate system used as a coordinate system for displaying a map, or may be a vehicle coordinate system fixed to the vehicle 2 in which the X-axis is a lateral direction (width direction) of the vehicle 2 and the Y-axis is a longitudinal direction (traveling direction) of the vehicle 2.

In the generation of the target trajectory, a speed plan is established. The speed plan defines passage time of each control point on the target trajectory. Since passing speed is uniquely determined by passing time of each control point determined when passing through the control points in order, defining the passing time of each control point on the target trajectory is also synonymous with defining the passing speed of each control point on the target trajectory. The speed plan can also be expressed as an acceleration pattern in which a planned acceleration is set in relation to time for each control position. The speed plan may also include a speed pattern in which a planned speed is set in relation to time for each control position.

The following control unit 42 performs following control for causing the vehicle 2 to follow the target trajectory. In the following control, a braking/driving force for matching an actual acceleration calculated from the speed sensor and a target acceleration determined based on the speed plan is calculated based on the deviation therebetween. The calculated braking/driving force is distributed to a required braking force required of the braking actuator 12 and a required driving force required of the driving actuator 13.

In the following control, feed-forward control and feedback control of the steering angle are performed. In the feedforward control, specifically, a control point on the target trajectory at a time which is a predetermined time before the current time (a center point when the target trajectory is a lane center line) is set as a reference point. Then, a feedforward value of the steering angle is calculated from the parameter corresponding to the reference point. The parameter referred to in the calculation of the feedforward value is, for example, a curvature of the target trajectory.

In the feedback control, a course of the vehicle 2 is predicted using information such as a vehicle speed, a lateral acceleration, a yaw rate, and the like measured by the vehicle sensor 21. Then, the predicted position and the predicted yaw angle of the vehicle 2 at a time which is a predetermined time before the current time are calculated from the predicted course. In the feedback control, a target lateral acceleration or a target yaw rate is calculated based on the magnitude of the deviation of the predicted position and the predicted yaw angle of the vehicle 2 with respect to the reference point on the target trajectory. Then, a feedback correction amount of the steering angle is calculated from the target lateral acceleration or the target yaw rate. The following control unit 42 calculates the sum of the feed-forward value and the feedback correction amount as a required steering angle.

The required steering angle calculated by the following control unit 42 is input to the steering control unit 43. The steering control unit 43 operates the steering actuator 11 in accordance with the required steering angle. The required braking force calculated by the following control unit 42 is input to the braking control unit 44. The braking control unit 44 operates the braking actuator 12 in accordance with the required braking force. The required driving force calculated by the following control unit 42 is input to the driving control unit 45. The driving control unit 45 operates the driving actuator 13 in accordance with the required driving force.

With the functions described above, the vehicle controller 30 can automatically travel the vehicle 2 to the destination. However, during automatic travel of the vehicle 2, disturbance that makes the behavior of the vehicle 2 unsteady may act on the vehicle 2. In order to prevent the passengers from feeling anxious and uncomfortable, unsteadiness of the behavior of the vehicle 2 due to disturbance should be suppressed. For this reason, the function of the vehicle controller 30 includes a function for driving assistance responsive to disturbance. More specifically, the vehicle controller 30 is provided with a preceding vehicle recognizing unit 51, an infrastructure information acquiring unit 52, a location recognizing unit 53, a disturbance estimating unit 54, a driver state determination unit 55, and a disturbance-responsive driving assistance unit 56. However, these units are not present as hardware in the vehicle controller 30, but are realized by software when a program stored in the memory 32 is executed by the processor 31. In the present embodiment, a lateral wind is assumed as disturbance acting on the vehicle 2.

The preceding vehicle recognizing unit 51 recognizes a preceding vehicle traveling ahead of the vehicle 2 from surrounding environment information obtained by the surrounding environment recognizing sensor 22. From infrastructure information received by the infrastructure information receiving unit 26, the infrastructure information acquiring unit 52 acquires infrastructure information relating to traveling conditions of the road on which the vehicle 2 is traveling. However, in the present embodiment, the infrastructure information related to traveling conditions means weather information, more specifically, lateral wind information. The location recognizing unit 53 recognizes a location where the vehicle 2 is traveling by comparing location information of the vehicle 2 obtained by the GPS unit 24 with map information provided from the map information unit 25.

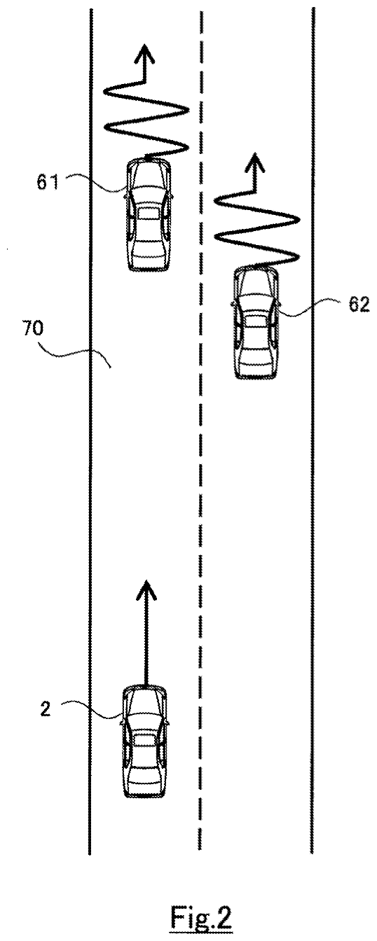

The behavior of a preceding vehicle recognized by the preceding vehicle recognizing unit 51, the infrastructure information acquired by the infrastructure information acquiring unit 52, and the location recognized by the location recognizing unit 53 are input to the disturbance estimating unit 54. These pieces of input information are used in the disturbance estimating unit 54 to estimate a lateral wind which is disturbance. Hereinafter, the estimation of a lateral wind based on each information will be described with reference to FIGS. 2 to 4.

FIG. 2 is a diagram for explaining estimation of a lateral wind based on behavior of a preceding vehicle. The vehicle 2 runs on a road 70, and two preceding vehicles 61 and 62 run ahead of it. While the vehicle 2 runs straight, the preceding vehicles 61 and 62 run while wandering from side to side. In such a case, it can be presumed that a lateral wind is blowing in the location where the preceding vehicles 61 and 62 are traveling, and it can be predicted that the lateral wind will also act on the vehicle 2. Further, it can be estimated that the stronger the lateral wind is blowing as the width of wandering of the preceding vehicles 61 and 62 is larger. In this case, the reliability of the estimation of a lateral wind, that is, the reliability of wandering of a preceding vehicle is higher as the number of preceding vehicles for which wandering has been detected is larger. Incidentally, for the detection of the wandering of the prior vehicles 61 and 62, for example, it is possible to use the well-known technology described in JP10-247299A or JP2018-91794A.

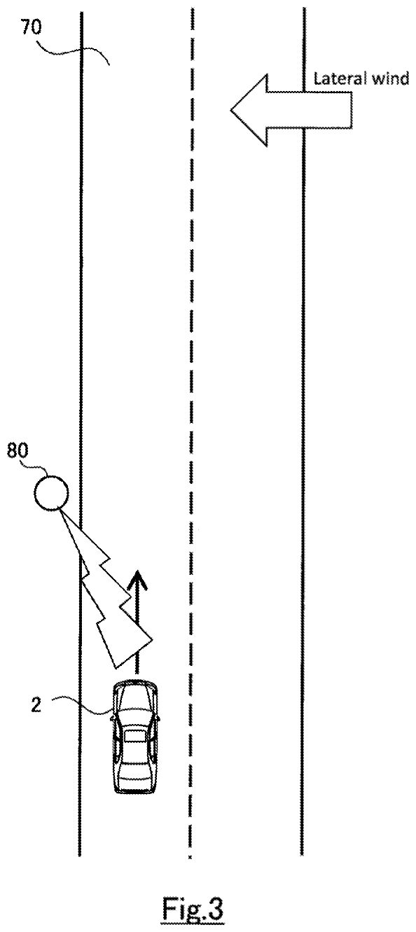

FIG. 3 is a diagram for explaining estimation of a lateral wind based on infrastructure information. Infrastructure information provided from a FM broadcasting station and a road facility 80 provided along the road 70 includes information on a lateral wind blowing forward in the traveling direction of the vehicle 2. For example, infrastructural information includes information such as “XX km ahead, beware of lateral wind”, “XX km ahead, beware of strong wind”, and the like. Infrastructure information of such a content can be used to reinforce the reliability of a lateral wind estimated from wandering of a preceding vehicle, or can be used to estimate a lateral wind to which the vehicle 2 is subjected.

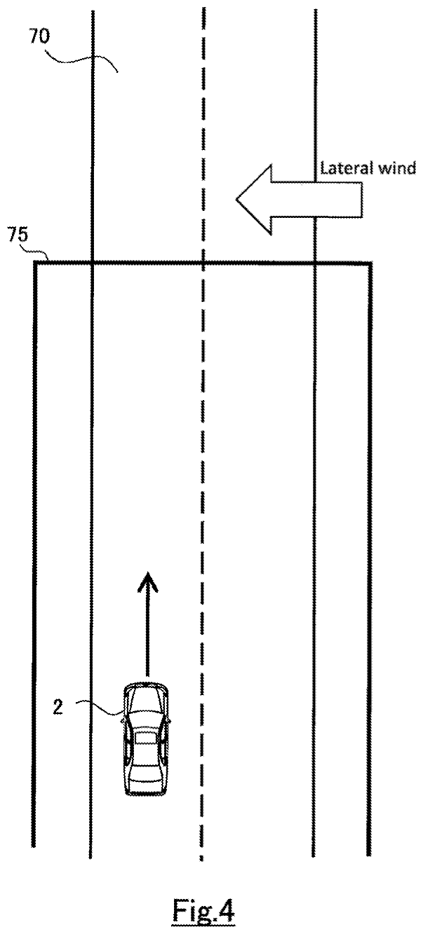

FIG. 4 is a diagram for explaining estimation of a lateral wind based on a location where the vehicle 2 is traveling. In the road 70, there are locations where a lateral wind is apt to blow and locations where it is not. For example, an exit of a tunnel 75 as shown in FIG. 4 is a location where a lateral wind is apt to blow. A road on a bridge is also one of locations where a lateral wind is apt to blow. The exit of the tunnel or the road on the bridge is not necessarily blown with a lateral wind, but whether the vehicle 2 is traveling on a location where a lateral wind is easily blown or not can be used to reinforce the reliability of a lateral wind estimated from wandering of a preceding vehicle and infrastructure information.

The disturbance estimating unit 54 estimates a lateral wind using the above input information, and calculates the reliability of the estimated lateral wind. When a lateral wind is estimated, the disturbance estimating unit 54 inputs information on the estimated direction and magnitude of the lateral wind to the disturbance-responsive driving assistance unit 56, which will be described later, and also inputs information on the reliability of the estimated lateral wind to the disturbance-responsive driving assistance unit 56. Since the reliability of the estimated lateral wind depends on the reliability of the detected wandering of a preceding vehicle, it is hereinafter referred to as wandering reliability instead of reliability of a lateral wind.

The driver state determination unit 55 determines the steering state of the driver from information on the driver's state obtained by the driver monitoring sensor 23. The steering state of the driver can be classified into three types: hands-on during steering, which is a state in which the driver is steering the steering wheel; hands-on without steering, which is a state in which the driver is touching the steering wheel but is not steering; and hands-off, which is a state in which the driver is not touching the steering wheel. The driver state determination unit 55 inputs the determined steering state of the driver to the disturbance-responsive driving assistance unit 56, which will be described later.

Determination of the steering state of the driver can be performed by a known method. For example, the steering state of the driver can be determined by a steering torque of the driver detected by a torque sensor. In this case, if the steering torque is equal to or greater than a first threshold value, it may be determined that it is the hands-on during steering, if the steering torque is less than the first threshold value and equal to or greater than a second threshold value which is greater than the first threshold value, it may be determined that it is hands-on without steering, and if the steering torque is less than the second threshold value, it may be determined that it is hands-off. In addition, hands-on may be detected by a touch sensor provided on the steering wheel. Further, when it is detected that the driver is not in a normal state from facial expression or posture of the driver or biological signals such as a heartbeat and a pulse, the steering state of the driver may be determined as hands-off.

The disturbance-responsive driving assistance unit 56 determines an assistance level of the driving assistance responsive to disturbance based on the wandering reliability input from the disturbance estimating unit 54 and the steering state of the driver input from the driver state determination unit 55. Then, the disturbance-responsive driving assistance unit 56 issues an instruction to the following control unit 42 to change the content of the following control in accordance with the determined assistance level. When changing the content of the control by the following control unit 42, the disturbance-responsive driving assistance unit 56 notifies the driver of the change of the control content via the HMI14.

### 3. DETERMINATION OF ASSISTANCE LEVEL OF DRIVING ASSISTANCE RESPONSIVE TO DISTURBANCE

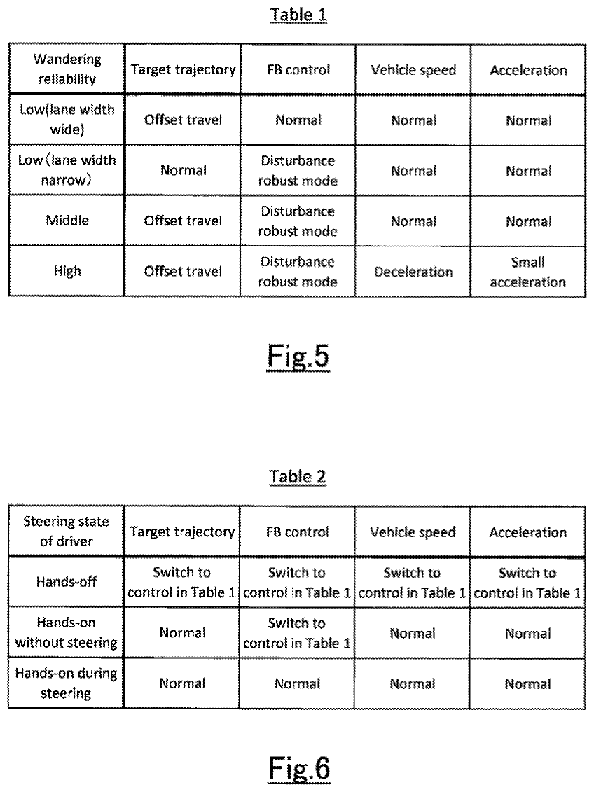

Specifically, determination of an assistance level of the driving assistance by the disturbance-responsive driving assistance unit 56 is performed according to Table 1 shown in FIG. 5 and Table 2 shown in FIG. 6.

In Table 1 shown in FIG. 5, the contents of the driving assistance control responsive to disturbance are described for each level of the wandering reliability. The items in the row of Table 1 are the levels of the wandering reliability. In Table 1, the wandering reliability is divided into “low”, “medium” and “high”, and the wandering reliability “low” is divided into a case where a lane width is narrow and a case where a lane width is wide. The lane width may be calculated from the distance between section lines recognized from camera images, or may be used when the lane width is included in the map information. The disturbance-responsive driving assistance unit 56 determines that the lane width is wide if it is a predetermined value or more, and determines that the lane width is narrow if it is less than the predetermined value.

The items in the column of Table 1 are the contents of the driving assistance control responsive to disturbance. The item “target trajectory” means a target trajectory used for following control. “Normal” and “offset travel” are defined in the “target trajectory”. “Normal” means that the following control is performed using the target trajectory generated by the target trajectory generating unit 41. On the other hand, the “offset travel” means that the target trajectory used in the following control is offset in the direction of the disturbance with respect to the target trajectory generated by the target trajectory generating unit 41. When comparing “normal” and “offset travel”, “offset travel” has a higher assistance level of the driving assistance.

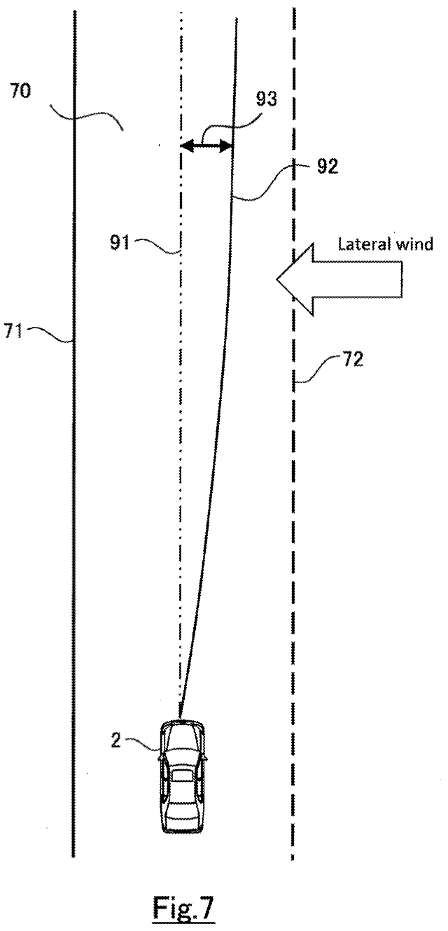

The offset of the target trajectory will be described in detail with reference to FIG. 7. FIG. 7 illustrates a state in which the vehicle 2 is automatically traveling on the road 70. Here, it is assumed that the target trajectory of the following control coincides with the lane center line 91 located at the center of the section lines 71 and 72 on both sides. In this case, when a lateral wind blowing from the rightward direction in the drawing of FIG. 7 is estimated, the target trajectory 93 used in the following control is offset in the rightward direction from the lane center line 91 which is the original target trajectory, that is, in the lateral wind direction. The offset amount of the target trajectory 93 with respect to the lane center line 91 used in the following control may be increased as the estimated lateral wind becomes stronger.

Returning to FIG. 5 again, Table 1 will be described. “FB control” in the column of Table 1 means feedback control of the steering angle. “Normal” and “disturbance robust mode” are defined in “FB control”. “Normal” means, as described above, a mode in which the target lateral acceleration or the target yaw rate is calculated based on the magnitude of the deviation of the predicted position and the predicted yaw angle of the vehicle 2 with respect to the reference point on the target trajectory, and the feedback correction amount of the steering angle is calculated from the target lateral acceleration or the target yaw rate. On the other hand, “disturbance robust mode” is a mode for enhancing robustness against disturbance, and a feedback correction amount for canceling an external force due to the disturbance is added. When comparing “normal” mode and the “disturbance robust mode”, “disturbance robust mode” has a higher assistance level of the driving assistance.

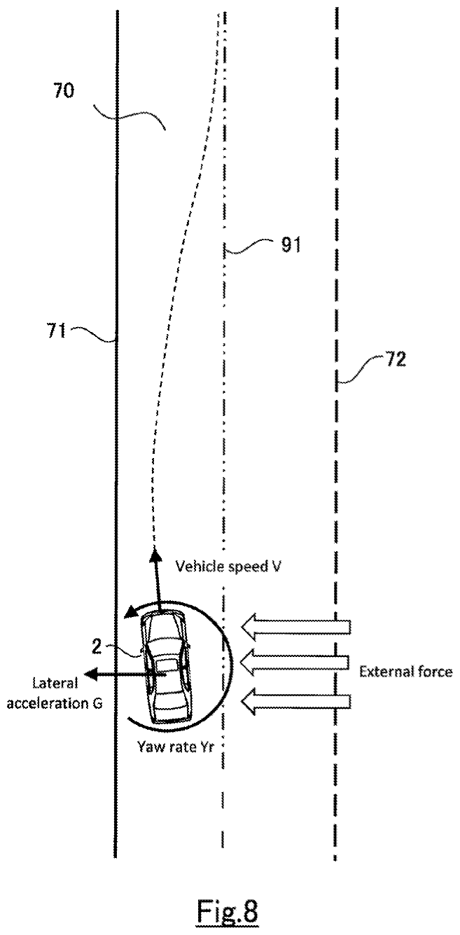

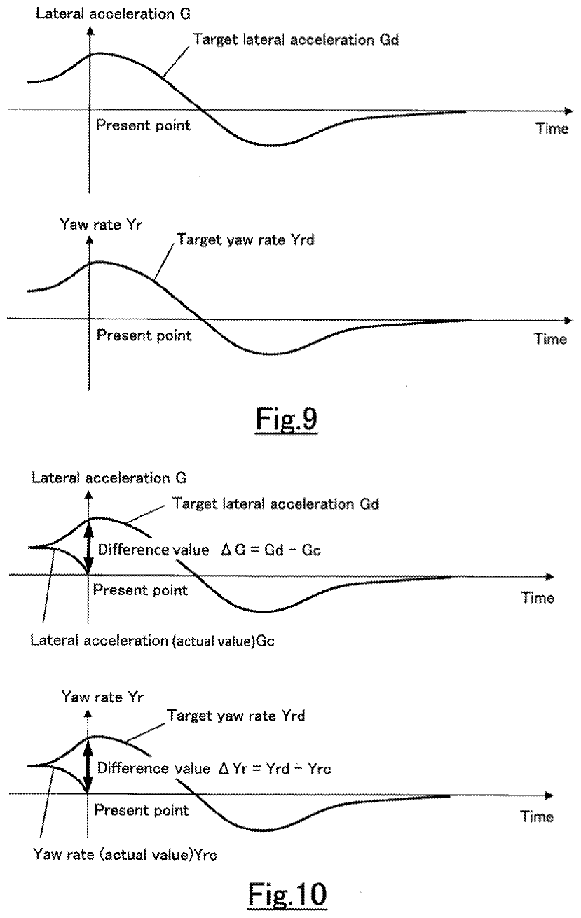

The disturbance robust mode of the FB control will be described in detail with reference to FIG. 8. FIG. 8 illustrates a state in which the vehicle 2 is automatically traveling on the road 70. Here, it is assumed that the target trajectory of the following control coincides with the lane center line 91 located at the center of the section lines 71 and 72. In the normal mode of the FB control, the target lateral acceleration or the target yaw rate is calculated based on the deviation of the predicted position and the predicted yaw angle of the vehicle 2 with respect to the lane centerline 91 which is the target trajectory. FIG. 9 is a diagram showing an example of the target lateral acceleration Gd and the target yaw rate Yrd. In this case, the feedback correction amount θpath of the steering angle is calculated by the following Equation 1 or Equation 2. Note that Kg in Equation 1 is the steering angle-lateral acceleration gain, and Kyr in Equation 2 is the steering angle-yaw rate gain.

θpath=Kg×Gd Equation 1

θpath=Kyr×Yrd Equation 2

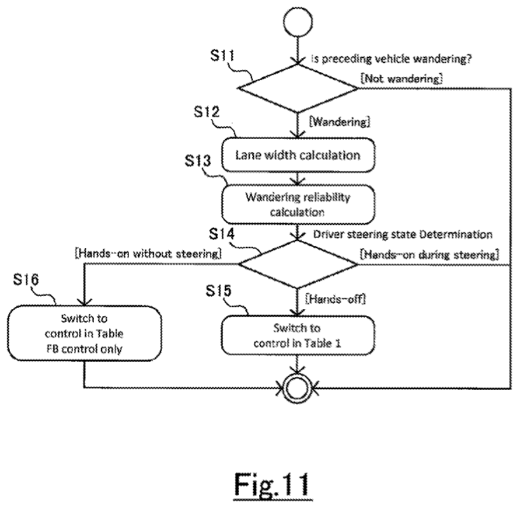

When no disturbance acts on the vehicle 2, the actual lateral acceleration and the actual yaw rate of the vehicle 2 coincide with the target lateral acceleration and the target yaw rate required to cause the vehicle 2 to follow the target trajectory. However, when disturbance acts on the vehicle 2, external force generated due to the disturbance makes a difference value ΔG generate between the target lateral acceleration Gd and the actual lateral acceleration Gc, and makes a difference value ΔYr generate between the target yaw rate Yrd and the actual yaw rate Yrc, as shown in FIG. 10. In the disturbance robust mode of the FB control, the feedback correction amount θdist of the steering angle for canceling the external force due to the disturbance is calculated on the basis of the lateral acceleration difference value ΔG or the yaw rate difference value ΔYr using Equation 3 or Equation 4 below. In the disturbance robust mode of the FB control, the sum of the feedback correction amount θpath and the feedback correction amount θdist is used as the feedback correction amount of the steering angle in the following control. Note that Kgdist in Equation 3 is the steering angle-lateral acceleration gain, and Kyrdist in Equation 4 is the steering angle-yaw rate gain. The gains Kgdist and Kyrdist may be increased as the estimated lateral wind becomes stronger.

θdist=Kgdist×ΔG Equation 3

θdist=Kyrdist×ΔYr Equation 4

Returning to FIG. 5 again, Table 1 will be described. “Vehicle speed” in the column of Table 1 means a vehicle speed of the vehicle 2 during automatic travel. “Normal” and “deceleration” are defined in “vehicle speed”. “Normal” means a mode in which the braking/driving force is calculated based on the target speed determined based on the speed plan. “Deceleration” means a mode in which the braking/driving force is calculated based on a speed lower than the target speed determined based on the speed plan. The wandering of the vehicle 2 due to a lateral wind tends to increase as the vehicle speed increases. In the driving assistance responsive to disturbance, the vehicle speed is lowered more than usual, so that the vehicle 2 is hardly affected by a lateral wind. When comparing “normal” and “deceleration”, “deceleration” has a higher assistance level of the driving assistance.

“Acceleration” in the column of Table 1 means the manner of acceleration of the vehicle 2 during automatic travel. “Normal” and “small acceleration” are defined in “acceleration”. “Normal” means a mode in which the braking/driving force is calculated based on the target acceleration determined based on the speed plan. “Small acceleration” means a mode in which the braking/driving force is calculated based on an acceleration reduced from the target acceleration determined based on the speed plan. Acceleration in a situation where the behavior of the vehicle 2 is unsteady due to disturbance may cause anxiety for passengers. In the driving assistance responsive to disturbance, by accelerating more slowly than usual, both the following ability to the target speed and the security of the passengers are achieved. When comparing “normal” and “small acceleration”, “small acceleration” has a higher assistance level of the driving assistance.

In the above-described column items, “target trajectory” and “FB control” are items relating to lateral driving assistance acting on lateral motion of the vehicle 2, and “vehicle speed” and “acceleration” are items relating to longitudinal driving assistance acting on longitudinal motion of the vehicle 2. According to Table 1, when the wandering reliability (the reliability of the lateral wind blowing estimated by the disturbance estimating unit 54) is low, the assistance level of the longitudinal driving assistance is made lower than the assistance level of the lateral direction driving assistance as compared with a case where the reliability is high.

Even if the disturbance estimating unit 54 estimates a lateral wind blowing, when the reliability thereof is low, the vehicle 2 is highly likely not to actually receive a lateral wind. In a situation where the vehicle 2 is unlikely to receive a lateral wind, by lowering the assistance level of the longitudinal driving assistance lower than the assistance level of the lateral direction driving assistance, it is possible to restrain the longitudinal driving assistance from causing the driver to feel uncomfortable. On the other hand, by keeping the assistance level of the lateral driving assistance having a higher contribution to the responsiveness to a lateral wind relatively high, it is possible to suppress unsteadiness of the vehicle behavior when the vehicle 2 is actually subjected to a lateral wind.

Further, according to Table 1, when the wandering reliability is low, the assistance level of the longitudinal driving assistance is made lower than that in a case where the wandering reliability is high. In a situation in which the vehicle 2 is unlikely to be subjected to a lateral wind, by lowering the assistance level of the longitudinal driving assistance, it is possible to restrain the longitudinal driving assistance from causing the driver to feel uncomfortable.

Further, according to Table 1, when the wandering reliability is low, the assistance level of the lateral driving assistance is made lower than that in a case where the wandering reliability is high. In a situation in which the vehicle 2 is unlikely to be subjected to a lateral wind, the assistance level of the lateral driving assistance is also lowered, thereby restraining the lateral driving assistance from causing the driver to feel uncomfortable. When the wandering reliability is low, “offset travel” of “target trajectory” is selected if the lane width is wide, but when the lane width is narrow, “disturbance robust mode” of “FB control” is selected in order to prevent departure of the vehicle 2 from the driving lane.

Next, determination of an assistance level of the driving assistance based on the steering state of the driver will be described with reference to Table 2 shown in FIG. 6. Table 2 shows the switching of the control according to the steering state of the driver. The items in the row of Table 2 are the steering states of the driver. In Table 2, the steering state of the driver is classified into “hands-off”, “hands-on without steering” and “hands-on during steering”. The items in the column of Table 2 are contents of the driving assistance control responsive to disturbance. Since each content of the driving assistance control is as described in Table 1, the description thereof is omitted here.

The items in the row of Table 2 are arranged in descending order of the responsiveness of the driver to the steering operation. The responsiveness of the driver to the steering operation means how quickly the steering operation can be started when the driver needs to perform the steering operation by himself/herself. In “hands-off” including a case where the driver is not in the normal state, the responsiveness of the driver to the steering operation is low. On the other hand, a high responsiveness can be expected in “hands-on during steering” in which the driver has already steered. According to Table 2, when the responsiveness of the driver to the steering operation is high, it is characterized in that an assistance level of the driving assistance is lowered as compared with a case where the responsiveness is low. Specifically, in “hands-off”, all the items are switched to the driving assistance control shown in Table 1, while in “hands-on without steering”, only the “FB control” is switched to the driving assistance control shown in Table 1, and in “hands-on during steering”, all the items are maintained in the normal following control. In a situation in which the vehicle 2 is subjected to a lateral wind and the driver can cope with the lateral wind by the steering operation, by lowering the assistance level of the driving assistance, it is possible to restrain the driving assistance from causing the driver to feel uncomfortable.

### 4. CONCRETE EXAMPLE OF DRIVING ASSISTANCE CONTROL RESPONSIVE TO DISTURBANCE

### 4-1. First Example

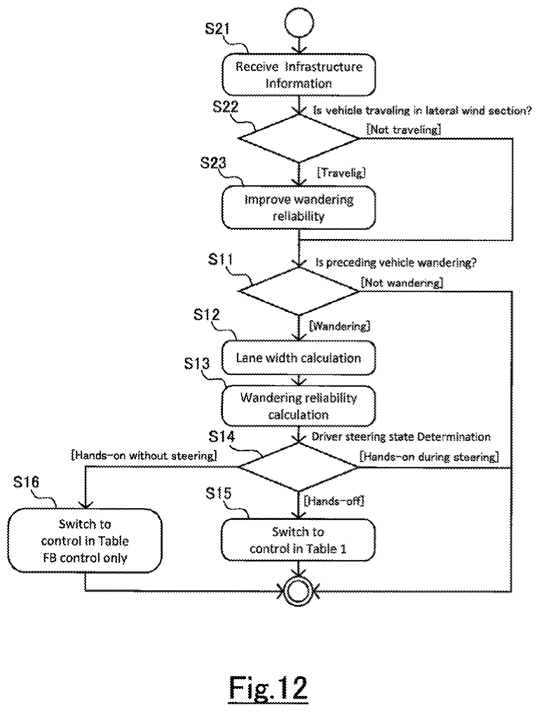

In a first example, the wandering of a preceding vehicle is determined, and the content of the driving assistance control is determined in accordance with the reliability of the wandering of the preceding vehicle and the steering state of the driver. FIG. 11 is a flowchart showing a control flow of the first example of the driving assistance control executed by the vehicle controller 30.

In step S11, the behavior of the preceding vehicle is recognized from the surrounding environment information obtained by the surrounding environment recognizing sensor 22, and it is determined whether or not the preceding vehicle is wandering. When the preceding vehicle is not wandering, switching to the driving assistance control is not performed, and the normal following control is maintained.

If the preceding vehicle is wandering, the control flow proceeds to step S12. In step S12, for example, the lane width is calculated from the distance between two section lines recognized from camera images. Next, in step S13, the wandering reliability is calculated based on the number of preceding vehicles for which wandering has been detected. The greater the number of wandering preceding vehicles, the greater the wandering reliability can be. The wandering reliability is determined from Table 1 by the processing of steps S12 and S13, and also the control which is performed is determined from Table 1.

Next, in step S14, it is determined whether the steering state of the driver is hands-off, hands-on without steering, or hands-on during steering. By comparing the determination result of step S14 with Table 2, the assistance level is determined for each item of the driving assistance control. When the steering state of the driver is hands-off, all the items of the driving assistance control are switched to the control of Table 1 in step S15. When the steering state of the driver is hands-on without steering, only the FB control is switched to the control of Table 1 in step S16. When the steering state of the driver is hands-on during steering, switching to the driving assistance control is not performed for any of the items, and the normal following control is maintained.

### 4-2. Second Example

In a second example, infrastructure information is acquired and used to reinforce the wandering reliability of a preceding vehicle. FIG. 12 is a flowchart showing a control flow of the second example of the driving assistance control executed by the vehicle controller 30. In the flowchart of the second example, the same step numbers are assigned to the processes having the same contents as those of the flowchart of the first example. In addition, the explanation of the processing with the contents common to those of the first example is omitted or simplified.

In the control flow of the second example, the process of step S21, the process of step S22, and the process of step S23 are performed prior to the determination of step S11. In step S21, infrastructure information relating to the travel route of the vehicle 2, in particular, weather information relating to a lateral wind is acquired from the infrastructure information acquired by the infrastructure information receiving unit 26. In step S22, it is determined whether or not the infrastructure information indicating that a lateral wind is blowing is received, and if such information is received, it is determined whether or not the vehicle 2 is traveling in a lateral wind section in which the lateral wind is blowing.

If the vehicle 2 is not traveling in the lateral wind section, the control flow proceeds to step S11. On the other hand, when the vehicle 2 is traveling in the lateral wind section, the process of improving the wandering reliability calculated in step S13 is performed. Specifically, if the infrastructure information received in step S21 is “beware of lateral wind”, the wandering reliability is increased by one level, and if the infrastructure information received in step S21 is “beware of strong wind”, the wandering reliability is increased by two levels. According to the infrastructure information, it is possible to predict in advance that the vehicle 2 receives a lateral wind. Therefore, by adding the infrastructure information to the estimation of a lateral wind blowing based on the behavior of the preceding vehicle, it is possible to improve the wandering reliability obtained from the behavior of the preceding vehicle.

### 4-3. Third Example

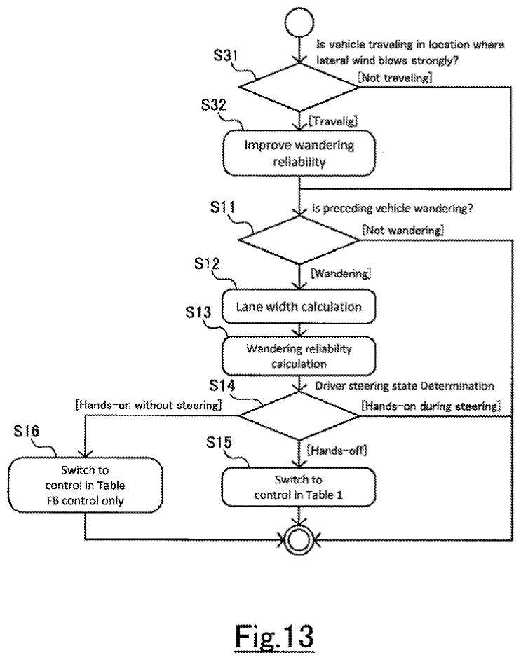

In a third example, information on the location where the vehicle 2 is traveling is acquired, and the location information is used to reinforce the wandering reliability of a preceding vehicle. FIG. 13 is a flowchart showing a control flow of the third example of the driving assistance control executed by the vehicle controller 30. In the flowchart of the third example, the same step numbers are assigned to the processes having the same contents as those of the flowchart of the first example. In addition, the explanation of the processing with the contents common to those of the first embodiment is omitted or simplified.

In the control flow of the third example, the determination of step S31 and the processing of step S32 are performed prior to the determination of step S11. In step S31, it is determined whether or not the vehicle 2 is traveling in a location where a lateral wind blows strongly, such as an exit of a tunnel or a road on a bridge.

If the vehicle 2 is not traveling in the location where a lateral wind blows strongly, the control flow proceeds to step S11. On the other hand, in a case where the vehicle 2 is traveling in the location where a lateral wind blows strongly, the process of improving the wandering reliability calculated in step S13 is performed. More specifically, the wandering reliability is increased by one level, and the threshold value for determining whether or not the preceding vehicle is wandering is lowered. The location where the vehicle 2 is traveling may or may not be susceptible to a lateral wind. By adding a location where the vehicle 2 is traveling to the estimation of a lateral wind blowing based on the behavior of the preceding vehicle, it is possible to improve the wandering reliability obtained from the behavior of the preceding vehicle.

### 4-4. Forth Example

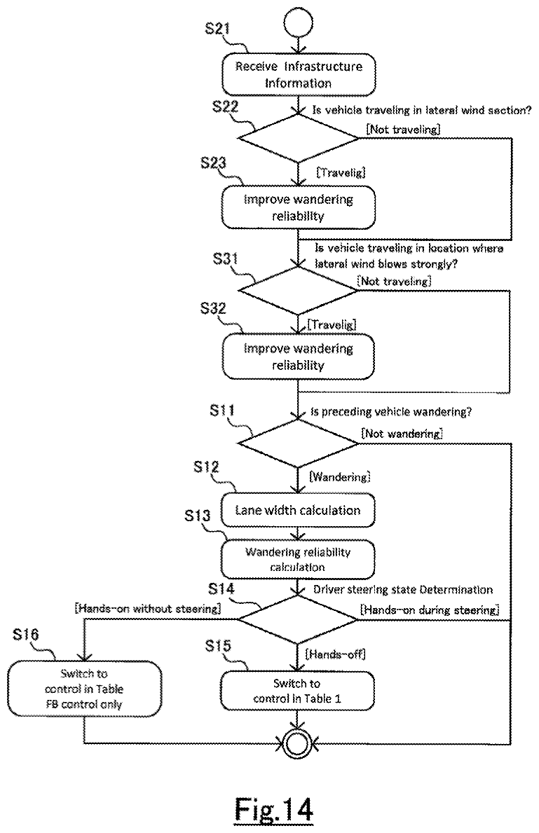

The fourth example is a combination of the second example and the third example. In the fourth example, infrastructure information is acquired, and the infrastructure information is used for reinforcing the wandering reliability of a preceding vehicle, while information on a location where the vehicle 2 is traveling is also acquired, and the location information is also used for reinforcing the wandering reliability of the preceding vehicle. FIG. 14 is a flowchart showing a control flow of the fourth example of the driving assistance control executed by the vehicle controller 30. In the flowchart of the fourth example, the same step numbers are assigned to the processes having the same contents as those of the flowcharts of the first to third examples. By combining the infrastructure information and the location where the vehicle 2 is traveling, it is possible to further improve the wandering reliability obtained from the behavior of the preceding vehicle.

### 4-5. Fifth Example

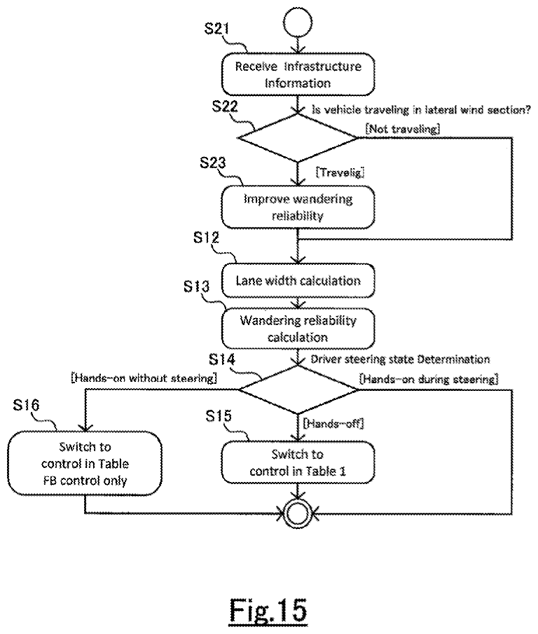

In a fifth example, instead of determining the wandering of a preceding vehicle, the reliability of the wandering of the preceding vehicle is calculated from infrastructure information, and the content of the driving assistance control is determined in accordance with the wandering reliability and the steering state of the driver. FIG. 15 is a flowchart showing a control flow of a fifth example of the driving assistance control executed by the vehicle controller 30. In the flowchart of the fifth example, the same step numbers are assigned to the processes having the same contents as those of the flowchart of the second example. In addition, the explanation of the processing with the contents common to those of the first or second embodiment is omitted or simplified.

According to the control flow of the fifth example, the determination of the presence or absence of the wandering based on the behavior of the preceding vehicle is not performed, and the calculation of the wandering reliability based on the number of the preceding vehicles in which the wandering is detected is not performed too. In the fifth example, the infrastructure information indicating that a lateral wind is blowing is received, and if the vehicle 2 is traveling in a lateral wind section in which the lateral wind is blowing, it is regarded that the preceding vehicle is wandering. In the fifth example, the wandering reliability is determined by the intensity of a lateral wind included in the infrastructure information. For example, if the infrastructure information received in step S21 is “beware of lateral wind”, the wandering reliability is set to “low”, and if the infrastructure information received in step S21 is “beware of strong wind”, the wandering reliability is set to “medium”. As in the fourth example, if the location where the vehicle 2 is traveling is combined with the infrastructure information, it is possible to further improve the wandering reliability obtained from the infrastructure information.

### 5. OTHER EMBODIMENTS

Although a lateral wind is assumed as disturbance acting on the vehicle in the above embodiment, the vehicle controller according to the present disclosure can cope with disturbance other than a lateral wind. For example, centrifugal force acts on the vehicle in the curved portion of a road. The centrifugal force can be considered as disturbance acting in the lateral direction of the vehicle. In some cases, a curved portion of a road has a cant inclined in the width direction. When the vehicle travels on a canted road, an external force acts inward on the vehicle. This external force can also be considered as disturbance acting in the lateral direction of the vehicle. In addition, a road may be sloped from the central to the shoulder to improve drainage. When the vehicle travels on such a road, an external force acts on the vehicle in the direction from the central to the shoulder. This external force can also be considered as disturbance acting in the lateral direction of the vehicle.

Those disturbances can be estimated from behavior of a preceding vehicle or from map information in some cases. As the driving assistance responsive to those disturbances, the driving assistance as described in the above embodiment may be used. However, when the reliability of the estimated disturbance is low, an assistance level of the driving assistance responsive to disturbance is made lower as compared with a case where the reliability is high. Thereby, even if the driving assistance is performed despite the fact that the disturbance does not actually act on the vehicle, it is possible to restrain the driving assistance from causing the driver to feel uncomfortable.

What is claimed is:

1. A vehicle controller comprising:
at least one processor; and
at least one memory coupled to the at least one processor, the at least one memory including at least one program that causes the at least one processor to execute:
first processing of estimating disturbance acting on a vehicle; and
second processing of performing driving assistance responsive to the disturbance,
wherein, when reliability of the disturbance estimated by the first processing is low, the at least one program causes the at least one processor to, in the second processing, lower assistance level of the driving assistance as compared with a case where the reliability is high.

2. The vehicle controller according to claim 1,
wherein the at least one program causes the at least one processor to, in the first processing, estimate a lateral wind received by the vehicle,
wherein the driving assistance includes lateral driving assistance acting on lateral motion of the vehicle and longitudinal driving assistance acting on longitudinal motion of the vehicle, and
wherein, when reliability of the lateral wind estimated by the first processing is low, the at least one program causes the at least one processor to, in the second processing, lower an assistance level of the longitudinal driving assistance more than an assistance level of the lateral driving assistance as compared with a case where the reliability is high.

3. The vehicle controller according to claim 1,
wherein the at least one program causes the at least one processor to, in the first processing, estimate a lateral wind received by the vehicle,
wherein the driving assistance includes longitudinal driving assistance acting on at least longitudinal motion of the vehicle, and
wherein, when reliability of the lateral wind estimated by the first processing is low, the at least one program causes the at least one processor to, in the second processing, lower an assistance level of the longitudinal driving assistance as compared with a case where the reliability is high.

4. The vehicle controller according to claim 1,
wherein the at least one program causes the at least one processor to, in the first processing, estimate a lateral wind received by the vehicle,
wherein the driving assistance includes lateral driving assistance acting on at least lateral motion of the vehicle, and
wherein, when reliability of the lateral wind estimated by the first processing is low, the at least one program causes the at least one processor to, in the second processing, lower an assistance level of the lateral driving assistance as compared with a case where the reliability is high.

5. The vehicle controller according to claim 1,
wherein the at least one program causes the at least one processor to execute third processing of determining a responsiveness of a driver to a steering operation, and
wherein, when the responsiveness of the driver to the steering operation determined by the third processing is high, the at least one program causes the at least one processor to, in the second processing, lower an assistance level of the driving assistance as compared with a case where the responsiveness is low.

6. The vehicle controller according to claim 2,
wherein the at least one program causes the at least one processor to execute fourth processing of recognizing a preceding vehicle traveling ahead of the vehicle, and
wherein the at least one program causes the at least one processor to, in the first processing, estimate the lateral wind received by the vehicle from behavior of the preceding vehicle recognized by the fourth processing.

7. The vehicle controller according to claim 6,
wherein the at least one program causes the at least one processor to execute fifth processing of acquiring infrastructure information relating to a traveling condition of a road on which the vehicle is traveling, and
wherein the at least one program causes the at least one processor to, in the first processing, correct the reliability of the lateral wind estimated from the behavior of the preceding vehicle based on the infrastructure information acquired by the fifth processing.

8. The vehicle controller according to claim 6,
wherein the at least one program causes the at least one processor to execute sixth processing of recognizing a location where the vehicle is traveling, and
wherein the at least one program causes the at least one processor to, in the first processing, correct the reliability of the lateral wind estimated from the behavior of the preceding vehicle based on the location recognized by the sixth processing.

9. The vehicle controller according to claim 2,
wherein the at least one program causes the at least one processor to execute fifth processing of acquiring infrastructure information relating to a traveling condition of a road on which the vehicle is traveling; and
wherein the at least one program causes the at least one processor to, in the first processing, estimate the lateral wind received by the vehicle from the infrastructure information acquired by the fifth processing.
